(19) United States
(12) Patent Application Publication
(10) Pub. No.: US 2006/0114788 A1
(43) Pub. Date: Jun. 1, 2006

(54) Optical disc apparatus and synchronous clock generation method of optical disc apparatus

(75) Inventor: Misao Fukuda, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 11/287,367

(22) Filed: Nov. 28, 2005

(30) Foreign Application Priority Data
Nov. 30, 2004 (JP) 2004-346998

(51) Int. Cl. G11B 5/09

(52) U.S. Cl. 369/59.19; 369/47.48

(57) ABSTRACT

An optical disc apparatus includes a plurality of phase-locked loops for outputting a signal corresponding to a synchronous clock that is generated based on a wobble formed in an optical disc, a selector for selecting and outputting one of outputs from the plurality of phase-locked loops, and a synchronous clock generator for generating the synchronous clock according to an output from the selector.

### BACKGROUND OF THE INVENTION

1. Field of the Invention

The present invention relates to an optical disc apparatus and particularly to a synchronous clock generator used when writing or reading an optical disc.

2. Description of Related Art

Optical discs such as CD and DVD are widely used as information recording media. Information on the information recording media is recorded or reproduced by applying laser beam onto a rotating optical disc. The optical disc wobbles a groove for recording information, thereby defining an absolute address.

When recording information on an optical disc by constant angular velocity (CAV), a synchronous clock for writing is generated based on the wobble. Japanese Unexamined Patent Publication No. 2003-115174 discloses a technique to generate a synchronous clock from a wobble signal. FIG. 3 shows the structure of an optical disc apparatus that writes and reads an optical disc.

In the apparatus shown in FIG. 3, a photodetector 204 detects the wobble in an optical disc 201 through a convex lens 202 and a half mirror 203. The detected wobble is photoelectrically converted by the photodetector 204. Then, a wobble signal is extracted through a current-voltage converter 205 and a differential amplifier 206.

The wobble signal is supplied to a phase-locked loop (PLL) 207. Based on this wobble signal, the PLL 207 generates a signal having a frequency to be a base for a synchronous clock that serves as a reference in write operation, which is referred to herein as the synchronous clock base signal. The synchronous clock base signal is pulsed by a pulser 208 and supplied as a synchronous clock to an LD driver 209. Besides the synchronous clock, the LD driver 209 receives an LD power control signal for controlling LD power in writing from a CPU 211.

The LD driver 209 controls a laser diode (LD) 210 to emit light according to the synchronous clock and the LD power control signal. The light emitted from the LD 210 is applied to the optical disc through the half mirror 203 and the convex lens 202. The heat of the laser light creates pits on the optical disc, thereby recording data.

In the case of recording information on an optical disc by CAV, the length of a recording surface that passes over a pickup per unit time changes between the inner periphery and the outer periphery of the optical disc. Accordingly, the frequency of the extracted wobble signal also changes between the inner periphery and the outer periphery. For example, in an optical disc such as CD and DVD with a radius of 60 mm, the frequency of the wobble signal in the outer periphery is more than twice of the wobble signal in the inner periphery. If a PLL with a wide lock range is therefore used to generate a synchronous clock, noise and jitter of a generated synchronous clock can be high due to the low accuracy of the PLL.

To avoid this, a conventional optical disc apparatus uses a PLL with a narrow lock range to generate a synchronous clock so as to lower noise and jitter. However, since the PLL with a narrow lock range fails to follow a change in frequency of the wobble signal between the inner periphery and the outer periphery of the optical disc, it has been sometimes necessary to suspend the write operation or the like that is in accordance with the synchronous clock during recording. During the suspension of the operation, the frequency dividing rate of PLL and the characteristics of a filter circuit in PLL are changed so that the characteristics of the PLL correspond to a change in frequency of the wobble signal. In this way, conventional techniques use the PLL with low noise and jitter and suspend the operation to change its characteristics, thus reducing noise and jitter by the PLL.

As described above, conventional optical disc apparatus suspend the operation that is in accordance with a synchronous clock when switching the characteristics of the PLL that serves as a circuit to generate a signal to be a base for the synchronous clock. In this case, the write operation, for example, resumes after changing the characteristics of the PLL in the state where the PLL is locked. This causes a problem that a recording speed is temporarily lowered while the operation is suspended (see FIG. 4).

### SUMMARY OF THE INVENTION

According to an aspect of the present invention, there is provided an optical disc apparatus that includes a plurality of phase-locked loops for outputting a signal corresponding to a synchronous clock that is generated based on a wobble formed in an optical disc, a selector for selecting and outputting one of outputs from the plurality of phase-locked loops, and a synchronous clock generator for generating the synchronous clock according to an output from the selector.

By selecting an output of one phase-locked loop from outputs of a plurality of phase-locked loops, it is possible to provide an optical disc apparatus without suspension of operation due to changing the settings of the phase-locked loop.

According to another aspect of the present invention, there is provided a synchronous clock generation method of an optical disc apparatus that includes generating a signal corresponding to a synchronous clock based on a wobble formed in an optical disc during a first period by a first phase-locked loop, adjusting settings of a second phase-locked loop during the first period, generating a signal corresponding to the synchronous clock based on a wobble formed in the optical disc during a second period by the second phase-locked loop, and adjusting settings of the first phase-locked loop during the second period.

By setting the second phase-locked loop during the first period, it is possible to generate a synchronous clock without suspending the operation due to a change in settings.

The present invention can provide an optical disc apparatus that allows use of a phase-locked loop with low noise and jitter of a synchronous clock even when a wobble frequency is changing and eliminates suspension of the operation that is in accordance with the synchronous clock.

### BRIEF DESCRIPTION OF THE DRAWINGS

The above and other objects, advantages and features of the present invention will be more apparent from the following description taken in conjunction with the accompanying drawings, in which:

FIG. 1 is a view showing the structure of an optical disc apparatus according to an embodiment of the present invention;

FIG. 2 is a view showing a relationship between a transfer rate and a phase-locked loop switching period according to an embodiment of the present invention;

FIG. 3 is a view showing the structure of an optical disc apparatus according to a conventional technique; and

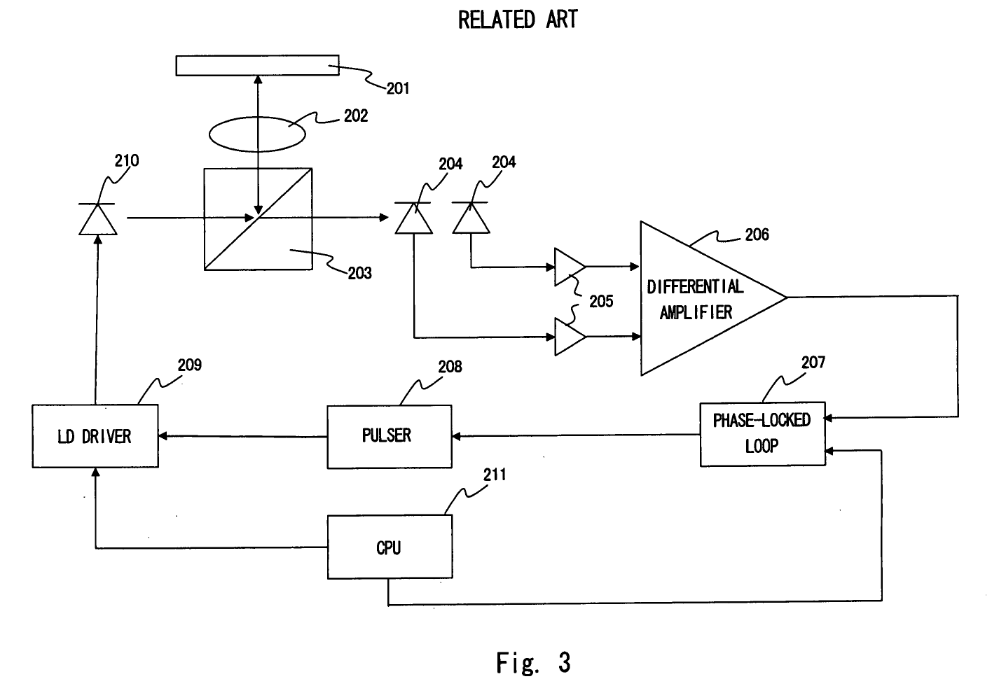

FIG. 4 is a view showing a relationship between a transfer rate and a change in settings of a phase-locked loop according to a conventional technique.

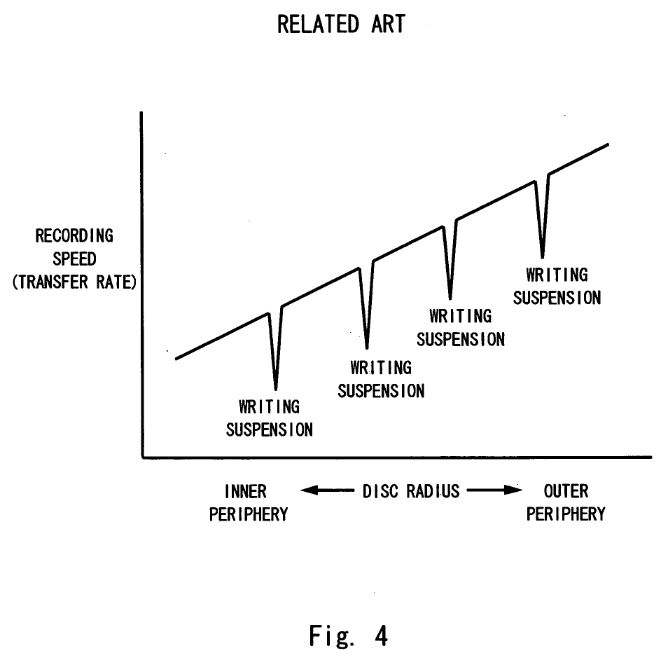

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

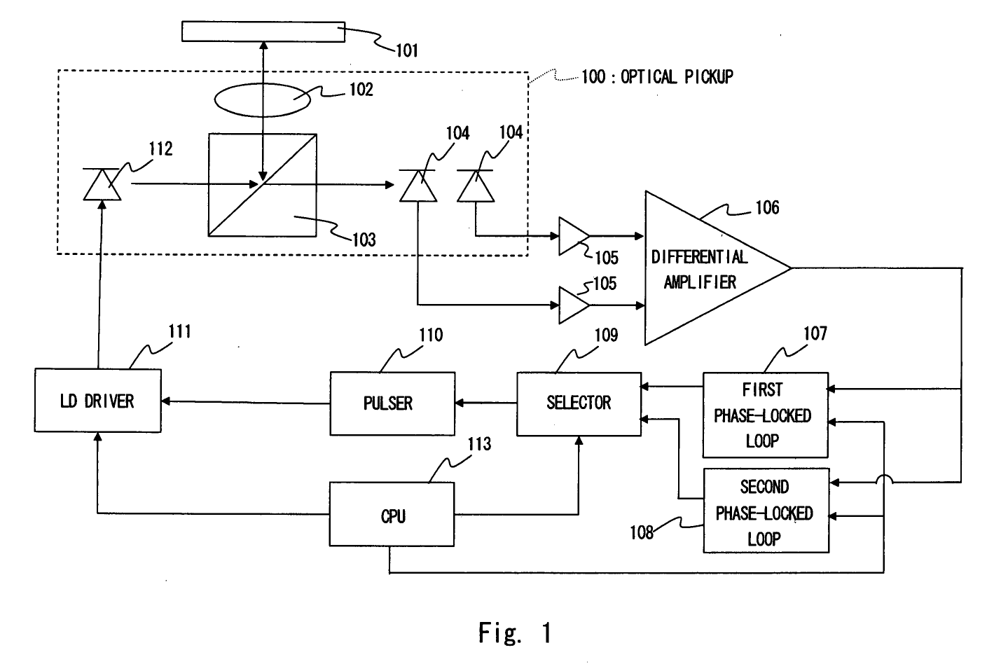

An embodiment of the present invention is described hereinafter with reference to the drawings. FIG. 1 shows a substantial part of an optical disc apparatus according to an embodiment of the present invention. The optical disc apparatus of this embodiment includes an optical pickup 100, a current-voltage converter 105, a differential amplifier (wobble signal output section) 106, a first phase-locked loop 107, a second phase-locked loop 108, a selector 109, a pulser 110, an LD driver 111, and a CPU (phase-locked loop setting section) 113.

The optical pickup 100 reads and writes data on a recording medium 101 such as DVD. The optical pickup 100 includes a convex lens 102, a half mirror 103, a photodetector 104, a laser diode (LD) 112 and so on.

The photodetector 104 detects a wobble formed in a groove of the optical disc 101 through the convex lens 102 and the half mirror 103. The photodetector 104 generates current corresponding to the wobble and supplies it to the current-voltage converter 105.

The current-voltage converter 105 converts a current signal corresponding to the wobble detected by the photodetector 104 into a voltage signal and supplies it to the differential amplifier 106. The differential amplifier 106 amplifies the voltage signal supplied from the current-voltage converter 105 and outputs it as a wobble signal. This embodiment inputs the wobble signal to the first phase-locked loop 107 and the second phase-locked loop 108.

The first phase-locked loop 107 and the second phase-locked loop 108 generate a signal having a frequency that is synchronous with the input wobble signal. The first phase-locked loop 107 and the second phase-locked loop 108 include a low-pass filter (LPF), a divider and so on, and they can change the settings such as a LPF cut-off frequency, frequency dividing rate and so on. The settings are determined according to a PLL setting signal that is supplied from the CPU 113. Thus, the characteristics of the first and second phase-locked loops 107 and 108 are determined according to the PLL setting signal. The first and second phase-locked loops 107 and 108 perform frequency dividing or other processing on the input wobble signal and then output it as a signal having a frequency to be a base for a synchronous clock, which is referred to as the synchronous clock base signal. The outputs from the first and second phase-locked loops 107 and 108 are supplied to the selector 109.

The selector 109 selects and outputs a synchronous clock base signal that is supplied from either one of the first phase-locked loop 107 or the second phase-locked loop 108 according to a selection signal from the CPU 113. The synchronous clock base signal selected by the selector 109 is then supplied to the pulser 110.

The pulser 110 pulses the synchronous clock base signal selected by the selector 109 and supplies it as a synchronous clock to the LD driver 111.

The LD driver 111 outputs a signal to drive a laser diode (LD) 112 according to the synchronous clock and a power control signal supplied from the CPU 113. The LD 112 emits light according to the signal supplied from the LD driver 111. The light emitted from the LD 112 is applied to the optical disc 101 through the half mirror 103 and the convex lens 102. The heat of the laser light creates pits to indicate data on the optical disc.

The CPU 113 is a control section that outputs control signals such as the PLL setting signal, the selection signal and the power control signal.

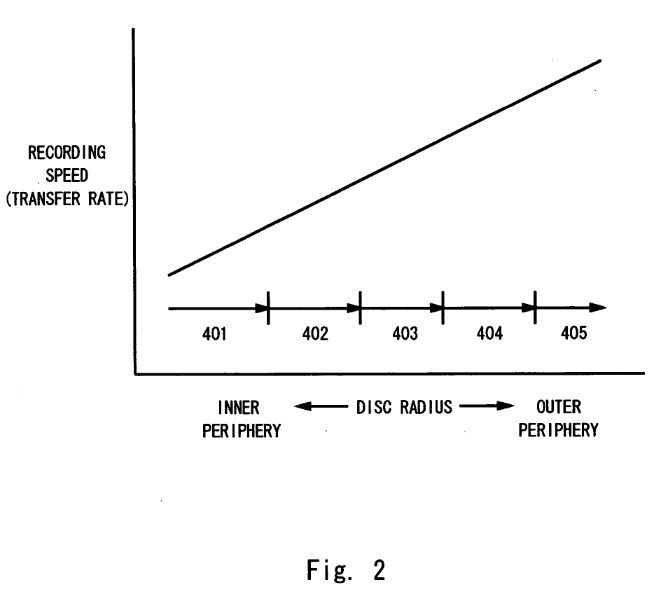

The operation of the optical disc apparatus of this embodiment is described hereinafter with reference to FIG. 2. The following description describes generation of a synchronous clock in write operation. The write operation is performed by CAV, which records data on an optical disc or the like from its inner periphery to outer periphery.

After data writing is started, the photodetector 104 generates a signal corresponding to wobble, and the wobble signal is supplied to the first and second phase-locked loops 107 and 108 through the current-voltage converter 105 and the differential amplifier 106. The first and second phase-locked loops 107 and 108 output synchronous clock base signals that are synchronous with the input wobble signal.

In a first period 401 immediately after the data writing is started, the CPU 113 supplies a signal to select the synchronous clock base signal that is output from the first phase-locked loop 107 to the selector 109. According to this selection signal, the selector 109 selects the synchronous clock base signal output from the first phase-locked loop 107 and supplies it to the pulser 110.

During the first period 401, the LD driver 111 operates in synchronization with a synchronous clock that is obtained by pulsing the synchronous clock base signal output from the first phase-locked loop 107, thereby writing data (see FIG. 2). Further, during the first period 401, the CPU 113 supplies a PLL setting signal to the second phase-locked loop 108 so as to change its settings. According to this PLL setting signal, the second phase-locked loop 108 sets an internal LPF or the like. Since this embodiment performs write operation from the inner periphery to the outer periphery of the optical disc, the frequency of the wobble signal gradually increases. Therefore, the second phase-locked loop 108 is set to be compatible with a higher frequency range than an average frequency of the wobble signal detected in the first period 401. Then, the second phase-locked loop 108 is locked to the frequency of the input wobble signal before the period shifts from the first to the second. Thus, the internal settings of the second phase-locked loop 108 are set so as to be compatible with the frequency of the wobble signal to be detected at least from the near end of the first period 401 to the second period 402. Specifically, the LPF cut-off frequency in the second phase-locked loop 108 is set higher than that in the first phase-locked loop 107. Further, the loop gain of the second phase-locked loop 108 is set lower than that of the first phase-locked loop 107.

After the period shifts from the first period 401 to the second period 402, the CPU 113 supplies a signal to select the synchronous clock base signal that is output from the second phase-locked loop 108 to the selector 109. According to this selection signal, the selector 109 selects the output from the second phase-locked loop 108 and supplies it to the pulser 110. The pulser 110 outputs a synchronous clock based on the synchronous clock base signal output from the second phase-locked loop 108. Then, the LD driver 111 drives the LD 112 according to the synchronous clock and the power control signal that is supplied from the CPU 113. The writing operation is thereby performed according to the synchronous clock base signal that is output from the second phase-locked loop 108.

At the same time, the CPU 113 supplies a PLL setting signal to the first phase-locked loop 107 in the second period 402 so as to change its settings. The first phase-locked loop 107 thereby changes the settings of the internal LPF or the like during the second period 402. The settings are changed so as to be compatible with the frequency range of the wobble signal to be detected in the third period 403, which is a higher frequency than an average frequency of the wobble signal that is detected in the second period. Specifically, the LPF cut-off frequency in the first phase-locked loop 107 is set higher than that in the second phase-locked loop 108. Further, the loop gain of the first phase-locked loop 107 is set lower than that of the second phase-locked loop 108.

Then, the first phase-locked loop 107 is locked to the frequency of the input wobble signal before the period shifts from the second to the third.

After that, the optical disc apparatus of this embodiment operates by repeating the similar process. In the third period 403, it selects the synchronous clock base signal that is output from the first phase-locked loop 107 to perform writing while changing the settings of the second phase-locked loop 108. Then, in the fourth period 404, it selects the synchronous clock base signal that is output from the second phase-locked loop 108 while changing the settings of the first phase-locked loop 107. In this embodiment, the write operation completes when the fifth period 405 ends.

The optical disc apparatus of this embodiment has a plurality of phase-locked loops and thereby keeps performing the write operation without interruption when changing the settings of the phase-locked loop as shown in FIG. 2. For example, when shifting from the first period 401 to the second period 402, it adjusts the settings of the second phase-locked loop 108 during the first period 401 in accordance with the frequency of the wobble signal to be detected in the second period 402 and locks the second phase-locked loop 108 to the frequency of the wobble signal before the first period 401 ends. Thus, when shifting to the second period 402, the optical disc apparatus can generate a synchronous clock that corresponds to the frequency of the wobble signal to be detected in the second period 402 merely by switching the synchronous clock base signal to be selected by the selector 109.

The optical disc apparatus of this embodiment thereby allows generating a synchronous clock with low noise and jitter by using a phase-locked loop with optimal settings in accordance with a changing frequency of a wobble signal even when writing data by CAV. Further, it eliminates the need for suspending the write operation to change the settings of the phase-locked loop, thus preventing a decrease in recording speed.

Though the above embodiment describes the case of writing data from the inner periphery to the outer periphery of an optical disc, the present invention is not limited thereto but is also applicable to a case of writing data from the outer periphery to the inner periphery. Further, the present invention is applicable not only to the write operation but also to read operation or the like as long as it generates a synchronous clock from a wobble signal. Furthermore, the number of the phase-locked loops to generate a synchronous clock base signal is not restricted to two, and a more number of phase-locked loops may be used. Though the above embodiment supplies a selection signal from the CPU 113 when selecting the output of the phase-locked loop, it is feasible to switch the output of the phase-locked loop to be selected in response to detection of a predetermined physical address on an optical disc.

Though the above embodiment pulses the selected synchronous clock base signal to obtain a synchronous clock, the pulser may be placed prior to the first and second phase-locked loops. In this case, it is feasible that the first and second phase-locked loops output first and second clocks, respectively, and the selector selects either one output and inputs it as a synchronous clock to the LD driver.

It is apparent that the present invention is not limited to the above embodiment and it may be modified and changed without departing from the scope and spirit of the invention.

What is claimed is:

1. An optical disc apparatus comprising:
a plurality of phase-locked loops for outputting a signal corresponding to a synchronous clock that is generated based on a wobble formed in an optical disc;
a selector for selecting and outputting one of outputs from the plurality of phase-locked loops; and
a synchronous clock generator for generating the synchronous clock according to an output from the selector.

2. The optical disc apparatus according to claim 1, wherein characteristics of a phase-locked loop of the plurality of phase-locked loops whose output is not selected by the selector are controlled by a setting signal.

3. The optical disc apparatus according to claim 1, wherein the optical disc is driven by constant angular velocity (CAV).

4. The optical disc apparatus according to claim 1, wherein a signal to control the selector is generated according to a physical address that is recorded on the optical disc.

5. The optical disc apparatus according to claim 2, further comprising:
an optical pickup for reading/writing the optical disc,
wherein the setting signal is controlled in accordance with a position of the optical pickup in a radial direction of the optical disc.

6. The optical disc apparatus according to claim 1, further comprising:
an optical pickup for reading/writing the optical disc;
a wobble signal output section for outputting a wobble signal based on the wobble to the plurality of phase-locked loops; and
a phase-locked loop setting section for outputting a first setting signal when the optical pickup is at a first position in a radial direction of the optical disc and outputting a second setting signal when the optical pickup is at a second position that is in an outer peripheral part compared to the first position in the radial direction of the optical disc,
wherein a phase-locked loop whose characteristics are set according to the second setting signal is compatible with the wobble signal having a higher frequency compared to a phase-locked loop whose characteristics are set according to the first setting signal.

7. The optical disc apparatus according to claim 6, wherein the second setting signal is a signal for setting a cut-off frequency of a low-pass filter in the phase-locked loop whose characteristics are set according to the second setting signal.

8. The optical disc apparatus according to claim 6, wherein the second setting signal is a signal for setting a loop gain of the phase-locked loop whose characteristics are set according to the second setting signal.

9. An optical disc apparatus comprising:
a first phase-locked loop for outputting a first clock based on a wobble formed in an optical disc;
a second phase-locked loop for outputting a second clock based on a wobble formed in the optical disc; and
a selector for selecting one from the first clock and the second clock and outputting the selected clock as a synchronous clock.

10. The optical disc apparatus according to claim 9, wherein characteristics of one of the first phase-locked loop and the second phase-locked loop whose output is not selected by the selector is controlled by a setting signal.

11. The optical disc apparatus according to claim 9, wherein the optical disc is driven by constant angular velocity (CAV).

12. The optical disc apparatus according to claim 9, wherein a signal to control the selector is generated according to a physical address that is recorded on the optical disc.

13. The optical disc apparatus according to claim 10, further comprising:
an optical pickup for reading/writing the optical disc,
wherein the setting signal is controlled in accordance with a position of the optical pickup in a radial direction of the optical disc.

14. The optical disc apparatus according to claim 9, further comprising:
an optical pickup for reading/writing the optical disc;
a wobble signal output section for outputting a wobble signal based on the wobble to the plurality of phase-locked loops; and
a phase-locked loop setting section for outputting a first setting signal when the optical pickup is at a first position in a radial direction of the optical disc and outputting a second setting signal when the optical pickup is at a second position that is in an outer peripheral part compared to the first position in the radial direction of the optical disc,
wherein a phase-locked loop whose characteristics are set according to the second setting signal is compatible with the wobble signal having a higher frequency compared to a phase-locked loop whose characteristics are set according to the first setting signal.

15. A synchronous clock generation method of an optical disc apparatus, comprising:
generating a signal corresponding to a synchronous clock based on a wobble formed in an optical disc during a first period by a first phase-locked loop;
adjusting settings of a second phase-locked loop during the first period;
generating a signal corresponding to the synchronous clock based on a wobble formed in the optical disc during a second period by the second phase-locked loop; and
adjusting settings of the first phase-locked loop during the second period.
